(19) United States
(12) Patent Application Publication
(10) Pub. No.: US 2022/0229388 A1
(43) Pub. Date: Jul. 21, 2022

(54) Heater and Image Forming Apparatus

(71) Applicant: Toshiba Lighting & Technology Corporation, Yokosuka-shi (JP)

(72) Inventors: Shinjiro Aono, Ehime-ken (JP); Atsushi Heike, Ehime-ken (JP); Masahiko Tamai, Ehime-ken (JP); Yoshitatsu Matsui, Ehime-ken (JP); Satoko Kato, Ehime-ken (JP)

(73) Assignee: Toshiba Lighting & Technology Corporation, Yokosuka-shi (JP)

(21) Appl. No.: 17/400,944

(22) Filed: Aug. 12, 2021

(30) Foreign Application Priority Data
Jan. 15, 2021 (JP) 2021-005295

(51) Int. Cl. G03G 15/20; H05B 3/26; H05B 3/12

(52) U.S. Cl. CPC G03G 15/2057; H05B 2203/007; H05B 3/12; H05B 3/262

(57) ABSTRACT

A heater according to an embodiment includes a substrate, a first wiring, a second wiring, and a plurality of first heating elements. Each first heating element includes an inclined portion, a first connecting portion, and a second connecting portion. When viewed from a direction perpendicular to the one surface of the substrate, the inclined portion is provided between the first wiring and the second wiring and inclined with respect to the first direction. An angle between the first (second) connecting portion side and the first (second) wiring side on an inclined portion side is larger than an angle between the first (second) wiring side on the inclined portion side and the inclined portion side on one (the other) side of the first direction where an angle between the inclined portion side and the first (second) wiring side on the inclined portion side is 90° or less.

### CROSS-REFERENCE TO RELATED APPLICATIONS

This application is based upon and claims the benefit of priority from Japanese Patent Application No. 2021-005295, filed on Jan. 15, 2021; the entire contents of which are incorporated herein by reference.

### FIELD

Embodiments described herein relate to a heater and an image forming apparatus.

### BACKGROUND

An image forming apparatus such as a copier or a printer is provided with a heater for fixing a toner. In general, such a heater is provided with a long substrate, a heating element provided on one surface of the substrate, and a wiring electrically connected to the heating element.

Further, there is a proposed heater having a pair of wirings extending along a long side of a substrate and a plurality of heating elements provided between the pair of wirings and arranged along the pair of wirings. One end of the plurality of heating elements is electrically connected to one of the wires. The other end of the plurality of heating elements is electrically connected to the other wiring. Further, the plurality of heating elements is inclined with respect to a direction in which the wirings extend. When such heating elements are provided, it is possible to suppress an occurrence of temperature distribution in the heater (substrate).

However, when the heating elements merely inclined with respect to the direction in which the wirings extend are provided, dielectric breakdown (electric field destruction) may occur at a connecting part between the heating elements and the wirings, and at least one of the heating elements and the wirings may be damaged.

Therefore, it is desired to develop a technology capable of suppressing dielectric breakdown at the connecting part between the heating elements and the wirings even when the heating elements inclined with respect to the direction in which the wirings extend are provided.

### DESCRIPTION OF THE DRAWINGS

FIG. 1 is a schematic plan view of a heater according to the present embodiment as viewed from a side where a heat generating portion is provided.

FIG. 2 is a schematic cross-sectional view of the heater of FIG. 1 in an A-A line direction.

FIG. 3 is a schematic plan view for illustrating planar shapes of heating elements according to a comparative example.

FIG. 4 is a schematic plan view for illustrating planar shapes of heating elements according to the present embodiment.

FIG. 5 is a schematic plan view for illustrating planar shapes of heating elements according to another embodiment.

FIG. 6 is a schematic diagram for illustrating an image forming apparatus according to the present embodiment.

FIG. 7 is a schematic diagram for illustrating a fixing portion.

### DETAILED DESCRIPTION

A heater according to an embodiment includes a substrate having a plate shape and extending in a first direction, a first wiring provided on one surface of the substrate to extend in the first direction, a second wiring provided on the one surface of the substrate and separated from the first wiring in a second direction orthogonal to the first direction, the second wiring extending in the first direction, and a plurality of first heating elements provided between the first wiring and the second wiring and arranged in the first direction. Each of the plurality of first heating elements includes an inclined portion, a first connecting portion provided on a first wiring side of the inclined portion and electrically connected to the first wiring, and a second connecting portion provided on a second wiring side of the inclined portion and electrically connected to the second wiring. When viewed from a direction perpendicular to the one surface of the substrate, the inclined portion is provided between the first wiring and the second wiring and inclined with respect to the first direction. An angle between a side of the first connecting portion and a side of the first wiring on an inclined portion side is larger than an angle between the side of the first wiring on the inclined portion side and a side of the inclined portion on one side of the first direction where an angle between the side of the inclined portion and a side of the first wiring on the inclined portion side is 90° or less. An angle between a side of the second connecting portion and a side of the second wiring on an inclined portion side is larger than an angle between the side of the second wiring on the inclined portion side and a side of the inclined portion on the other side of the first direction where an angle between the side of the inclined portion and a side of the second wiring on the inclined portion side is 90° or less.

Hereinafter, embodiments will be illustrated with reference to the drawings. Note that in each drawing, similar components are designated by the same reference symbols and detailed description thereof will be omitted as appropriate.

In addition, arrows X, Y, and Z in each drawing represent three directions orthogonal to one another. For example, a longitudinal direction of a substrate is set to an X direction (corresponding to an example of a first direction), a short direction (width direction) of the substrate is set to a Y direction (corresponding to an example of a second direction), and a direction perpendicular to a surface of the substrate (thickness direction) is set to a Z direction.

First, a heater 1 according to the present embodiment will be described.

(Heater)

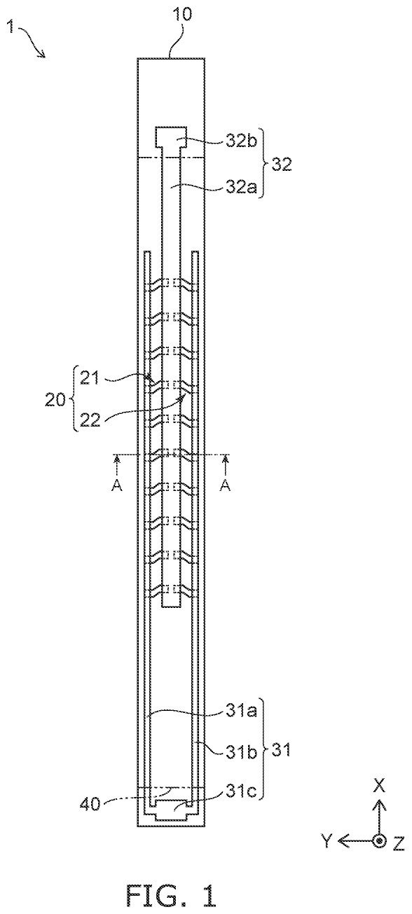

FIG. 1 is a schematic plan view of the heater 1 according to the present embodiment as viewed from a side where a heat generating portion 20 is provided.

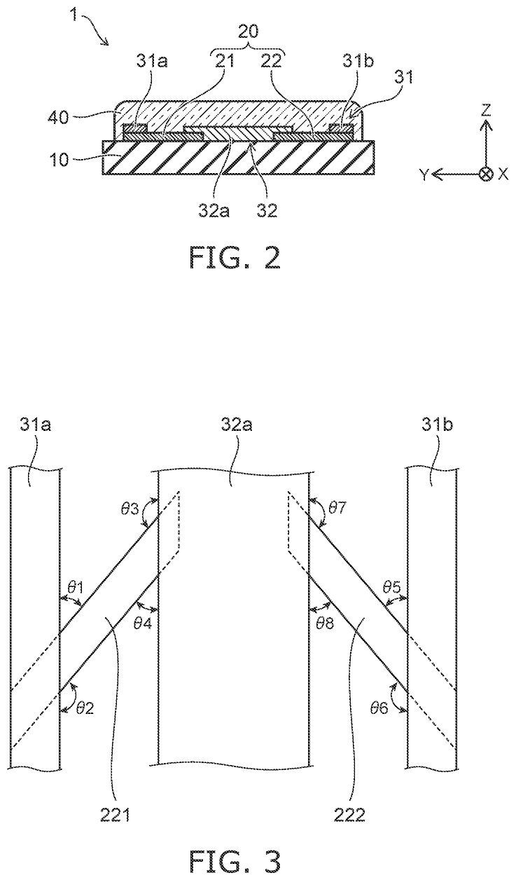

FIG. 2 is a schematic cross-sectional view of the heater 1 of FIG. 1 in an A-A line direction.

As illustrated in FIGS. 1 and 2, for example, the heater 1 includes a substrate 10, the heat generating portion 20, a wiring portion 31, a wiring portion 32, and a protective film 40.

The substrate 10 has a plate shape and has a shape extending in one direction (for example, the X direction). A planar shape of the substrate 10 can be, for example, a long rectangular shape. A thickness of the substrate 10 can be, for example, about 0.5 mm to 1.0 mm. The plane dimensions of the substrate 10 can be appropriately changed depending on the size of an object to be heated (for example, paper), etc.

The substrate 10 is formed from a material having a heat-resisting property and an insulation property. The substrate 10 can be formed from, for example, ceramics such as aluminum oxide or aluminum nitride, crystallized glass (glass ceramics), and a metal plate whose surface is coated with an insulating material.

The heat generating portion 20 converts applied electric power into heat (Joule heat). The heat generating portion 20 is provided on one surface of the substrate 10.

The heat generating portion 20 has, for example, a plurality of heating elements 21 and a plurality of heating elements 22. The plurality of heating elements 21 is arranged in the X direction, for example. The plurality of heating elements 22 is arranged in the X direction, for example. Rows of the plurality of heating elements 21 and rows of the plurality of heating elements 22 are arranged in the Y direction.

Note that as an example, the plurality of heating elements 21 arranged in a row and the plurality of heating elements 22 arranged in a row were illustrated. However, any of the plurality of heating elements 21 and the plurality of heating elements 22 may be provided. Further, a plurality of heating elements provided side by side in the X direction may be provided in three or more rows in the Y direction. The number, plane dimensions, thickness, arrangement, etc. of the heating elements can be appropriately changed according to the size of the object to be heated, etc. Further, it is possible to provide heating elements having different plane dimensions and thicknesses, and it is possible to provide heating elements having at least one of the same plane dimensions and the same thickness.

Note that details regarding planar shapes of the heating elements 21 and the heating elements 22 will be described later.

For example, the plurality of heating elements 21 and the plurality of heating elements 22 have a film shape and can be formed by using ruthenium oxide (RuO₂), a silver-palladium (Ag—Pd) alloy, graphite, etc. For example, the plurality of heating elements 21 and the plurality of heating elements 22 may be formed by applying a paste-like material to the surface of the substrate 10 using a screen printing method, etc., and curing the paste-like material using a firing method, etc.

The wiring portion 31 and the wiring portion 32 are provided on the surface of the substrate 10 on which the heat generating portion 20 is provided.

The wiring portion 31 has, for example, a wiring 31a (corresponding to an example of a first wiring), a wiring 31b (corresponding to an example of the first wiring), and a terminal 31c. The wiring 31a, the wiring 31b, and the terminal 31c can be integrally formed.

In the Y direction, the wiring 31a is provided near one peripheral edge of the substrate 10. The wiring 31a extends in the X direction along one peripheral edge of the substrate 10.

In the Y direction, the wiring 31b is provided near the other peripheral edge of the substrate 10. The wiring 31b extends in the X direction along the other peripheral edge of the substrate 10.

The terminal 31c is provided near one end of the substrate 10 in the X direction. One end of each of the wiring 31a and the wiring 31b is electrically connected to the terminal 31c.

In the Y direction, the wiring portion 32 is provided in a central region of the substrate 10. The wiring portion 32 has, for example, a wiring 32a (corresponding to an example of a second wiring) and a terminal 32b. The wiring 32a and the terminal 32b can be integrally formed.

In the Y direction, the wiring 32a is provided between the wiring 31a and the wiring 31b of the wiring portion 31. That is, the wiring 32a is separated from the wirings 31a and 31b in the Y direction orthogonal to the X direction. The wiring 32a extends in the X direction along the peripheral edge of the substrate 10.

The terminal 32b is provided near the other end of the substrate 10 in the X direction. One end of the wiring 32a is electrically connected to the terminal 32b.

One end of the plurality of heating elements 21 is electrically connected to the wiring 31a of the wiring portion 31. The other end of the plurality of heating elements 21 is electrically connected to the wiring 32a of the wiring portion 32. That is, the plurality of heating elements 21 is connected in parallel.

One end of the plurality of heating elements 22 is electrically connected to the wiring 31b of the wiring portion 31. The other end of the plurality of heating elements 22 is electrically connected to the wiring 32a of the wiring portion 32. That is, the plurality of heating elements 22 is connected in parallel.

The wiring portion 31 and the wiring portion 32 may be formed by using a material containing, for example, silver or copper. In this case, for example, the wiring portion 31 and the wiring portion 32 may be formed by applying a paste-like material to the surface of the substrate 10 on which the heat generating portion 20 is provided by using the screen printing method, etc., and curing the paste-like material using the firing method, etc.

The protective film 40 covers the heating element 21, the heating element 22, the wiring portion 31, and the wiring portion 32. In this case, the terminal 31c of the wiring portion 31 and the terminal 32b of the wiring portion 32 can be exposed from the protective film 40 for electrical connection with a power-supply, etc.

For example, the protective film 40 has a function to insulate the heating element 21, the heating element 22, the wiring portion 31, and the wiring portion 32, a function to transfer heat generated in the heating element 21 and the heating element 22 to the outside, and a function of protecting the heating element 21, the heating element 22, the wiring portion 31, and the wiring portion 32 from external force, corrosive gas, etc.

The protective film 40 is preferably formed from a material having a heat-resisting property and an insulation property and having high chemical stability. For example, the protective film 40 can be formed using ceramics, glass, etc. In this case, when glass to which a filler containing a material having high thermal conductivity such as aluminum oxide is added is used, the protective film 40 can be easily formed. For example, the thermal conductivity of the glass to which the filler is added can be set to 2 [W/(m·K)] or more. For example, the protective film 40 can be formed by applying the paste-like material onto the substrate 10, the heat generating portion 20, the wiring portion 31, and the wiring portion 32 using the screen printing method, etc., and curing the paste-like material using the firing method, etc.

Further, a temperature sensor and a wiring electrically connected to the temperature sensor may be provided on the surface of the substrate 10 opposite to the side on which the heat generating portion 20 is provided. The temperature sensor can be, for example, a film-like thermistor. The film-like thermistor can be formed by, for example, applying a paste-like material to the surface of the substrate 10 by using a screen printing method, etc., and curing the paste-like material by using a firing method, etc. For example, the film-like thermistor can be formed by using a material containing barium titanate, a material containing an oxide, etc. The oxide can be, for example, an oxide of nickel, manganese, cobalt, iron, copper, etc.

The wiring electrically connected to the temperature sensor can be formed by using, for example, a screen printing method, a firing method, etc., similarly to the wiring portions 31 and 32 described above. In addition, it is possible to provide a protective film that covers the temperature sensor and the wiring. The protective film can be, for example, similar to the protective film 40 described above.

Next, a description will be given of planar shapes of the heating element 21 and the heating element 22.

First, a description will be given of planar shapes of heating elements 221 and 222 according to a comparative example.

FIG. 3 is a schematic plan view for illustrating the planar shapes of the heating elements 221 and 222 according to the comparative example.

As illustrated in FIG. 3, the planar shape of each of the heating elements 221 and 222 is a parallelogram.

The heating element 221 is electrically connected to the wiring 31a and the wiring 32a. The heating element 221 is inclined with respect to a direction (X direction) in which the wiring 31a and the wiring 32a extend.

As illustrated in FIG. 3, an angle θ1 between one side of the heating element 221 intersecting the wiring 31a and the wiring 31a is smaller than 45°. An angle θ2 between the other side of the heating element 221 intersecting the wiring 31a and the wiring 31a is larger than 135°. An angle θ3 between one side of the heating element 221 intersecting the wiring 32a and the wiring 32a is larger than 135°. An angle θ4 between the other side of the heating element 221 intersecting the wiring 32a and the wiring 32a is smaller than 45°.

The heating element 222 is electrically connected to the wiring 31b and the wiring 32a. The heating element 222 is inclined with respect to the wiring 31b and the wiring 32a.

As illustrated in FIG. 3, an angle θ5 between one side of the heating element 222 intersecting the wiring 31b and the wiring 31b is smaller than 45° . An angle θ6 between the other side of the heating element 222 intersecting the wiring 31b and the wiring 31b is larger than 135°. An angle θ7 between one side of the heating element 222 intersecting the wiring 32a and the wiring 32a is larger than 135°. An angle θ8 between the other side of the heating element 222 intersecting the wiring 32a and the wiring 32a is smaller than 45°. Here, when an angle between the heating element and the wiring is smaller than 45° (acute angle), electric field concentration is likely to occur in the vicinity of a connecting part between the heating element and the wiring. For example, electric field concentration is likely to occur at portions of angles θ1, θ4, θ5, and θ8. In this case, as the angle between the heating element and the wiring decreases, the strength of the electric field increases. When the strength of the electric field increases, dielectric breakdown occurs in the vicinity of the connecting part between the heating element and the wiring, and a large current may flow. For example, when an inrush current or a surge current flows through the heater 1, dielectric breakdown is more likely to occur. When dielectric breakdown occurs and a large current flows, there is concern that at least one of the heating element and the wiring may be damaged.

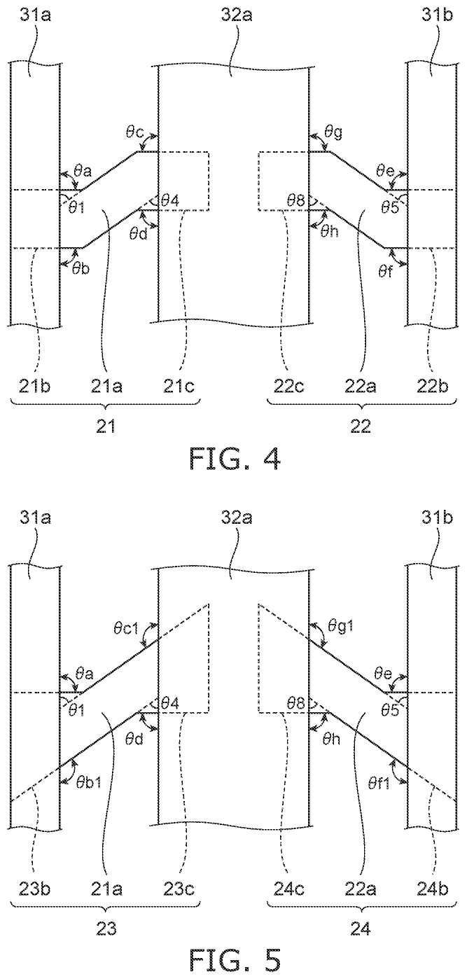

FIG. 4 is a schematic plan view for illustrating planar shapes of the heating elements 21 and 22 according to the present embodiment.

As illustrated in FIG. 4, the heating element 21 has an inclined portion 21a, a connecting portion 21b (corresponding to an example of a first connecting portion), and a connecting portion 21c (corresponding to an example of a second connecting portion). The inclined portion 21a, the connecting portion 21b, and the connecting portion 21c are integrally formed.

The inclined portion 21a is provided between the wiring 31a and the wiring 32a when viewed from the direction (Z direction) perpendicular to the surface of the substrate 10 on which the heating element 21 is provided. Further, the inclined portion 21a is inclined with respect to the direction (X direction) in which the wiring 31a and the wiring 32a extend. In this case, as illustrated in FIG. 1, when a plurality of inclined portions 21a inclined with respect to the longitudinal direction of the substrate 10 is provided side by side in the longitudinal direction of the substrate 10, it is possible to suppress occurrence of temperature distribution in the heater 1 (substrate 10).

The connecting portion 21b is provided on the wiring 31a side of the inclined portion 21a. The connecting portion 21b is electrically connected to the wiring 31a. The inclined portion 21a side of the connecting portion 21b is exposed from the wiring 31a.

Angles θa and θb between a side of the connecting portion 21b and a side of the wiring 31a on the inclined portion 21a side when viewed from the direction (Z direction) perpendicular to the surface of the substrate 10 on which the heating element 21 is provided are 45° or more. In the case of the heating element 21 illustrated in FIG. 4, the angles θa and θb are set to 90°. The planar shape of the connecting portion 21b can be, for example, a rectangle or a square. The connecting portion 21c is provided on the wiring 32a side of the inclined portion 21a. The connecting portion 21c is electrically connected to the wiring 32a. The inclined portion 21a side of the connecting portion 21c is exposed from the wiring 32a.

When viewed from the direction (Z direction) perpendicular to the surface of the substrate 10 on which the heating element 21 is provided, angles θc and θd between the side of the connecting portion 21c and the side of the wiring 32a on the inclined portion 21a side are 45° or more. In the case of the heating element 21 illustrated in FIG. 4, the angles θc and θd are set to 90°.

The planar shape of the connecting portion 21c can be, for example, a rectangle or a square.

As illustrated in FIG. 4, the heating element 22 has an inclined portion 22a, a connecting portion 22b (corresponding to an example of the first connecting portion), and a connecting portion 22c (corresponding to an example of the second connecting portion). The inclined portion 22a, the connecting portion 22b, and the connecting portion 22c are integrally formed.

The inclined portion 22a is provided between the wiring 31b and the wiring 32a when viewed from the direction (Z direction) perpendicular to the surface of the substrate 10 on which the heating element 22 is provided. Further, the inclined portion 22a is inclined with respect to the direction (X direction) in which the wiring 31b and the wiring 32a extend. In this case, as illustrated in FIG. 1, when a plurality of inclined portions 22a inclined with respect to the longitudinal direction of the substrate 10 is provided side by side in the longitudinal direction of the substrate 10, it is possible to suppress occurrence of temperature distribution in the heater 1 (substrate 10).

The connecting portion 22b is provided on the wiring 31b side of the inclined portion 22a. The connecting portion 22b is electrically connected to the wiring 31b. The inclined portion 22a side of the connecting portion 22b is exposed from the wiring 31b.

When viewed from the direction (Z direction) perpendicular to the surface of the substrate 10 on which the heating element 22 is provided, angles θe and θf between the side of the connecting portion 22b and the side of the wiring 31b on the inclined portion 22a side are 45° or more. In the case of the heating element 22 illustrated in FIG. 4, the angles θe and θf are set to 90°.

The planar shape of the connecting portion 22b can be, for example, a rectangle or a square.

The connecting portion 22c is provided on the wiring 32a side of the inclined portion 22a. The connecting portion 22c is electrically connected to the wiring 32a. The inclined portion 22a side of the connecting portion 22c is exposed from the wiring 32a.

When viewed from the direction (Z direction) perpendicular to the surface of the substrate 10 on which the heating element 22 is provided, angles θg and θh between the side of the connecting portion 22c and the side of the wiring 32a on the inclined portion 22a side are 45° or more. In the case of the heating element 22 illustrated in FIG. 4, the angles θg and θh are set to 90°.

The planar shape of the connecting portion 22c can be, for example, a rectangle or a square.

When the angle between the heating element and the wiring is 45° or more, it is possible to suppress the occurrence of electric field concentration in the vicinity of the connecting part between the heating element and the wiring. In addition, the strength of the generated electric field can be reduced. Therefore, for example, even when an inrush current or a surge current flows through the heater 1, it is possible to suppress dielectric breakdown at the connecting part between the heating elements 21 and 22 and the wirings 31a, 31b, and 32a. As a result, damage to the heating elements 21 and 22 and the wirings 31a, 31b, and 32a can be suppressed. FIG. 5 is a schematic plan view for illustrating planar shapes of heating elements 23 and 24 according to another embodiment.

As illustrated in FIG. 5, the heating element 23 has an inclined portion 21a, a connecting portion 23b (corresponding to an example of the first connecting portion), and a connecting portion 23c (corresponding to an example of the second connecting portion). The inclined portion 21a, the connecting portion 23b, and the connecting portion 23c are integrally formed. The connecting portion 23b is provided on the wiring 31a side of the inclined portion 21a. The connecting portion 23b is electrically connected to the wiring 31a. The inclined portion 21a side of the connecting portion 23b is exposed from the wiring 31a.

When viewed from the direction (Z direction) perpendicular to the surface of the substrate 10 on which the heating element 23 is provided, angles θa and θb1 between the side of the connecting portion 23b and the side of the wiring 31a on the inclined portion 21a side are 45° or more. In the case of the heating element 23 illustrated in FIG. 5, the angle θa is set to 90°, and the angle θb1 is set to be larger than 90°.

The planar shape of the connecting portion 23b can be, for example, a trapezoid.

The connecting portion 23c is provided on the wiring 32a side of the inclined portion 23a. The connecting portion 23c is electrically connected to the wiring 32a. The inclined portion 23a side of the connecting portion 23c is exposed from the wiring 32a.

When viewed from the direction (Z direction) perpendicular to the surface of the substrate 10 on which the heating element 23 is provided, angles θc1 and θd between the side of the connecting portion 23c and the side of the wiring 32a on the inclined portion 23a side are 45° or more. In the case of the heating element 23 illustrated in FIG. 5, the angle θc1 is set to be larger than 90°, and the angle θd is set to 90°.

The planar shape of the connecting portion 23c can be, for example, a trapezoid.

As illustrated in FIG. 5, the heating element 24 has an inclined portion 22a, a connecting portion 24b (corresponding to an example of the first connecting portion), and a connecting portion 24c (corresponding to an example of the second connecting portion). The inclined portion 22a, the connecting portion 24b, and the connecting portion 24c are integrally formed.

The connecting portion 24b is provided on the wiring 31b side of the inclined portion 22a. The connecting portion 24b is electrically connected to the wiring 31b. The inclined portion 22a side of the connecting portion 24b is exposed from the wiring 31b.

When viewed from the direction (Z direction) perpendicular to the surface of the substrate 10 on which the heating element 24 is provided, angles θe and θf1 between the side of the connecting portion 24b and the side of the wiring 31b on the inclined portion 22a side are 45° or more. In the case of the heating element 24 illustrated in FIG. 5, the angle θe is set to 90°, and the angle θf1 is set to be larger than 90°.

The planar shape of the connecting portion 24b can be, for example, a trapezoid.

The connecting portion 24c is provided on the wiring 32a side of the inclined portion 22a. The connecting portion 24c is electrically connected to the wiring 32a. The inclined portion 22a side of the connecting portion 24c is exposed from the wiring 32a.

When viewed from the direction (Z direction) perpendicular to the surface of the substrate 10 on which the heating element 24 is provided, angles θg1 and θh between the side of the connecting portion 24c and the side of the wiring 32a on the inclined portion 22a side is 90° or more. In the case of the heating element 24 illustrated in FIG. 5, the angle θg1 is set to be larger than 90° and the angle θh is set to 90°.

The planar shape of the connecting portion 24c can be, for example, a trapezoid.

Even the heating elements 23 and 24 having the above-mentioned planar shape can have the same actions and effects as those of the heating elements 21 and 22 described above.

That is, when viewed from the direction (Z direction) perpendicular to the surface of the substrate 10 on which the heating element is provided, as long as the angle between the connecting portion of the heating element and the wiring is 90° or more, the planar shape of the connecting portion can be changed as appropriate.

As described with reference to FIG. 4, the angle between the side of the connecting portion 21b (22b) and the side of the wiring 31a (31b) on the inclined portion 21a (22a) side is larger than the angle between the side of the wiring 31a (31b) on the inclined portion 21a (22a) side and the side of the inclined portion 21a (22a) on one side in the X direction where the angle between the side of the inclined portion 21a (22a) and the side of the wiring 31a (31b) on the inclined portion 21a (22a) side is 90° or less.

The angle between the side of the connecting portion 21c (22c) and the side of the wiring 32a on the inclined portion 21a (22a) side is larger than the angle between the side of the wiring 32a on the inclined portion 21a (22a) side and the side of the inclined portion 21a (22a) on the other side in the X direction where the angle between the side of the inclined portion 21a (22a) and the side of the wiring 32a on the inclined portion 21a (22a) side is 90° or less.

As described with reference to FIG. 5, the angle between the side of the connecting portion 23b (24b) and the side of the wiring 31a (31b) on the inclined portion 21a (22a) side is larger than the angle between the side of the wiring 31a (31b) on the inclined portion 21a (22a) side and the side of the inclined portion 21a (22a) on one side in the X direction where the angle between the side of the inclined portion 21a (22a) and the side of the wiring 31a (31b) on the inclined portion 21a (22a) side is 90° or less.

The angle between the side of the connecting portion 23c (24c) and the side of the wiring 32a on the inclined portion 21a (22a) side is larger than the angle between the side of the wiring 32a on the inclined portion 21a (22a) side and the side of the inclined portion 21a (22a) on the other side in the X direction where the angle between the side of the inclined portion 21a (22a) and the side of the wiring 32a on the inclined portion 21a (22a) side is 90° or less.

Next, a description will be given of an image forming apparatus 100 according to the present embodiment.

(Image Forming Apparatus)

In the following, as an example, a case where the image forming apparatus 100 is a copier will be described. However, the image forming apparatus 100 is not limited to the copier, and may be any one provided with a heater for fixing the toner. For example, the image forming apparatus 100 may be a printer, etc.

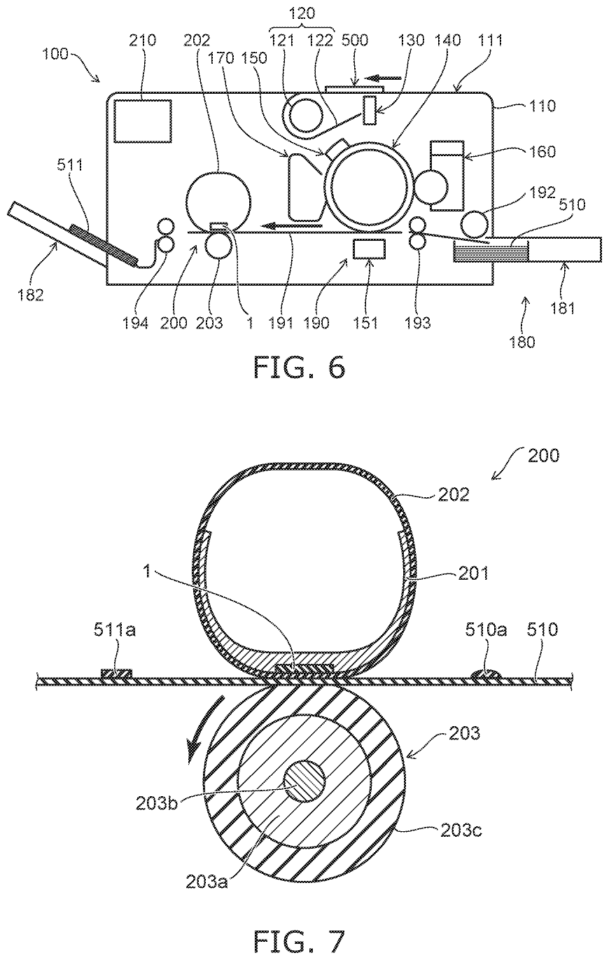

FIG. 6 is a schematic diagram for illustrating the image forming apparatus 100 according to the present embodiment.

FIG. 7 is a schematic diagram for illustrating a fixing portion 200.

As illustrated in FIG. 6, in the image forming apparatus 100, it is possible to provide a frame 110, an illumination portion 120, an imaging element 130, a photosensitive drum 140, a charging portion 150, a discharging portion 151, a developing portion 160, a cleaner 170, a storage portion 180, a transport portion 190, a fixing portion 200, and a controller 210.

The frame 110 has a box shape, and can store the illumination portion 120, the imaging element 130, the photosensitive drum 140, the charging portion 150, the developing portion 160, the cleaner 170, a part of the storage portion 180, the transport portion 190, the fixing portion 200, and the controller 210 therein.

A window 111 made of a translucent material such as glass can be provided on an upper surface of the frame 110. An original document 500 to be copied can be placed on the window 111. In addition, a moving portion for moving a position of the original document 500 can be provided.

The illumination portion 120 can be provided in the vicinity of the window 111. The illumination portion 120 can include a light source 121 such as a lamp and a reflector 122.

The imaging element 130 can be provided in the vicinity of the window 111.

The photosensitive drum 140 can be provided below the illumination portion 120 and the imaging element 130. The photosensitive drum 140 can be provided so as to be rotatable. For example, a zinc oxide photosensitive layer or an organic semiconductor photosensitive layer can be provided on a surface of the photosensitive drum 140.

The charging portion 150, the discharging portion 151, the developing portion 160, and the cleaner 170 can be provided around the photosensitive drum 140.

The storage portion 180 has a cassette 181 and a tray 182. The cassette 181 can be detachably attached to one side of the frame 110. The tray 182 can be provided in a side portion of the frame 110 on the opposite side from a side where the cassette 181 is mounted. The cassette 181 stores paper 510 (for example, blank paper) before copying is performed. The tray 182 stores the paper 511 on which a copy image 511a is fixed.

The transport portion 190 can be provided below the photosensitive drum 140. The transport portion 190 transports the paper 510 between the cassette 181 and the tray 182. The transport portion 190 includes a guide 191 that supports the paper 510 to be transported, and transport rollers 192 to 194 that transport the paper 510. Further, the transport portion 190 may be provided with a motor for rotating the transport rollers 192 to 194.

The fixing portion 200 can be provided on a downstream side (tray 182 side) of the photosensitive drum 140.

As illustrated in FIG. 7, the fixing portion 200 includes, for example, a heater 1, a stay 201, a film belt 202, and a pressure roller 203.

The heater 1 can be attached to a transport line side of the paper 510 of the stay 201. The heater 1 can be embedded in the stay 201. A side of the heater 1 provided with the protective film 40 can be exposed from the stay 201. The film belt 202 covers the stay 201 provided with the heater 1. The film belt 202 can contain, for example, a resin having a heat-resisting property such as polyimide.

The pressure roller 203 can be provided so as to face the stay 201. The pressure roller 203 has a core metal 203a, a drive shaft 203b, and an elastic portion 203c. The drive shaft 203b protrudes from an end of the core metal 203a and is connected to a drive device such as a motor. The elastic portion 203c can be provided on an outer surface of the core metal 203a. The elastic portion 203c is formed of an elastic material having a heat-resisting property. The elastic portion 203c contains, for example, a silicone resin, etc.

The controller 210 is provided inside the frame 110. The controller 210 has, for example, a calculation unit such as a central processing unit (CPU) and a storage unit in which a control program is stored. The calculation unit controls an operation of each element provided in the image forming apparatus 100 based on a control program stored in the storage unit. Further, the controller 210 may include an operation unit for inputting copying conditions, etc. by a user, a display unit for displaying an operating state, an abnormality display, etc.

Note that since a known technology can be applied to control the operation of each element provided in the image forming apparatus 100, detailed description thereof will be omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A heater comprising:
a substrate having a plate shape and extending in a first direction;
a first wiring provided on one surface of the substrate to extend in the first direction;
a second wiring provided on the one surface of the substrate and separated from the first wiring in a second direction orthogonal to the first direction, the second wiring extending in the first direction; and
a plurality of first heating elements provided between the first wiring and the second wiring and arranged in the first direction,
each of the plurality of first heating elements including
an inclined portion,
a first connecting portion provided on a first wiring side of the inclined portion and electrically connected to the first wiring, and
a second connecting portion provided on a second wiring side of the inclined portion and electrically connected to the second wiring,
when viewed from a direction perpendicular to the one surface of the substrate,
the inclined portion being provided between the first wiring and the second wiring and inclined with respect to the first direction,
an angle between a side of the first connecting portion and a side of the first wiring on an inclined portion side being larger than an angle between
the side of the first wiring on the inclined portion side and
a side of the inclined portion on one side of the first direction where an angle between the side of the inclined portion and a side of the first wiring on the inclined portion side is 90° or less, and
an angle between a side of the second connecting portion and a side of the second wiring on an inclined portion side being larger than an angle between
the side of the second wiring on the inclined portion side and
a side of the inclined portion on the other side of the first direction where an angle between the side of the inclined portion and a side of the second wiring on the inclined portion side is 90° or less.

2. The heater according to claim 1,
wherein the angle between the side of the first connecting portion and the side of the first wiring on the inclined portion side is 45° or more, and
the angle between the side of the second connecting portion and the side of the second wiring on the inclined portion side is 45° or more.

3. The heater according to claim 1,
wherein the angle between the side of the first connecting portion and the side of the first wiring on the inclined portion side is 90° or more, and
the angle between the side of the second connecting portion and the side of the second wiring on the inclined portion side is 90° or more.

4. The heater according to claim 1, wherein when viewed from a direction perpendicular to the one surface of the substrate, inclination angles of a plurality of inclined portions with respect to the first direction are substantially the same.

5. The heater according to claim 1, wherein the inclined portion side of the first connecting portion is exposed from the first wiring.

6. The heater according to claim 1, wherein a planar shape of the first connecting portion is any one of a rectangle, a square, and a trapezoid.

7. The heater according to claim 1, wherein the inclined portion side of the second connecting portion is exposed from the second wiring.

8. The heater according to claim 1, wherein a planar shape of the second connecting portion is any one of a rectangle, a square, and a trapezoid.

9. The heater according to claim 1, wherein the inclined portion, the first connecting portion, and the second connecting portion are integrally formed.

10. The heater according to claim 1, wherein each of the plurality of first heating elements has a film shape.

11. The heater according to claim 1, wherein the plurality of first heating elements contains at least one of ruthenium oxide (RuO₂), a silver-palladium (Ag—Pd) alloy, and graphite.

12. The heater according to claim 1, wherein the first wiring contains at least one of silver and copper.

13. The heater according to claim 1, wherein the second wiring contains at least one of silver and copper.

14. The heater according to claim 1, further comprising:
a third wiring provided on the one surface of the substrate and provided on a side of the second wiring opposite to the first wiring side in the second direction, the third wiring extending in the first direction; and
a plurality of second heating elements provided between the second wiring and the third wiring and arranged in the first direction.

15. The heater according to claim 14, wherein the plurality of second heating elements is provided at positions line-symmetric with the plurality of first heating elements with a center line of the second wiring as an axis of symmetry.

16. The heater according to claim 14, wherein the plurality of second heating elements has a shape line-symmetric with the plurality of first heating elements with a center line of the second wiring as an axis of symmetry.

17. The heater according to claim 14, wherein each of the plurality of second heating elements has a film shape.

18. The heater according to claim 14, wherein the plurality of second heating elements contains at least one of ruthenium oxide (RuO₂), a silver-palladium (Ag—Pd) alloy, and graphite.

19. The heater according to claim 14, wherein the third wiring contains at least one of silver and copper.

20. An image forming apparatus comprising
the heater according to claim 1.
